(19) United States
(12) Patent Application Publication
(10) Pub. No.: US 2009/0057517 A1
(43) Pub. Date: Mar. 5, 2009

(54) BEVERAGE CONTAINER AND SUPPORT AND HOLDER THEREFOR

(76) Inventor: Mohammed Ayub Hanif, Waterdown (CA)

Correspondence Address: MANELLI DENISON & SELTER, 2000 M STREET NW SUITE 700, WASHINGTON, DC, 20036-3307, US

(21) Appl. No.: 12/194,595

(22) Filed: Aug. 20, 2008

(30) Foreign Application Priority Data
Aug. 31, 2007 (CA) 2,600,095

(51) Int. Cl. B60R 7/04

(52) U.S. Cl. 248/311.2

(57) ABSTRACT

A beverage cup retaining system in a vehicle, having, in combination,
(i) a beverage container holder within the vehicle;
(ii) a beverage container for holding liquid beverage, having a lid with a displaceable portion, displaceable to provide an aperture in the lid through which the beverage may be drank, and retained within the vehicle holder; and
(iii) a support within the holder and upon the support the beverage container rests within the holder; and wherein the support is so shaped as to cause the beverage container to be sufficiently tilted when resting on the support as to cause the level of the beverage adjacent the aperture to be lower than the level of the beverage when the container is horizontal.

### FIELD OF THE INVENTION

This invention relates to a beverage container, particularly, a coffee cup, and a distinct support therefor for use with a beverage container holder, particularly, said holder present in a vehicle.

### BACKGROUND OF THE INVENTION

Beverage containers, for example coffee cups, are often provided with removable lids having a detachable, displaceable, optionally, recloseable portion, activated by manual lifting to provide a suitable aperture through which the beverage may be drank. Although generally, optionally, recloseable, the displaced portion or tab is invariably not used to fully seal the lid and provide a liquid seal to prevent spillage.

Such beverage containers with lids are extensively retained in suitably shaped, i.e. invariably cylindrical holders, for example, in movable vehicles, such as automobiles, trucks and the like. This enables the driver to periodically reach for the container and sip the beverage. Few drivers go to the bother of sealing the lid portion with the rest of the lid, which often requires the driver to take his/her eyes off the road.

However, rapid movement, by acceleration or braking, or rapid turning of the vehicle, often causes portions of the beverage to spill out of the container through the aperture to cause unwanted beverage contamination of the holder in the vehicle.

There is, therefore, a need for a system that reduces the risk of spillage of beverage from a container when the latter is held in a holder, particularly in a vehicle.

### SUMMARY OF THE INVENTION

It is an object of the present invention to provide a system for reducing the risk of spillage from a beverage container held in a moveable vehicle.

In a broad aspect, the invention provides a beverage cup retaining system in a vehicle, comprising, in combination,

(i) a beverage container holder means within the vehicle;

(ii) a beverage container for holding liquid beverage, having a lid with a displaceable portion to provide an aperture in said lid through which said beverage may be drank, and retained within said vehicle holder means; and

(iii) support means within said holder means and upon said support, said beverage container rests within said holder means; and wherein said support is so shaped as to cause said beverage container to be sufficiently tilted when resting on said support as to cause the level of the beverage adjacent said aperture to be lower than the level of the beverage when said container is horizontal.

In one aspect, the holder means defines a portion selected from a lower part or at the base of the holder means, and wherein the support means is integrally formed with the holder means at the lower part or the base of the holder means. Preferably, the portion is a protrusion extending outwardly around a circumferential portion of the holder means, or extending upwardly from a circumferential portion of the base.

In a further aspect the invention provides a system as hereinabove defined comprising, in combination,

(a) a beverage container, for retaining a liquid beverage, having a lid with a displaceable portion to provide an aperture in said lid through which said beverage may be drank;

(b) holder means having an inner base in a vehicle for holding said beverage container;

(c) a base support within said holder means and upon said support, said beverage container rests within said holder means; and wherein said support is so shaped as to cause said beverage container to be sufficiently tilted when resting on said support as to cause the level of the beverage adjacent said aperture to be lower than the level of the beverage when said container is horizontal.

Preferably, the holder comprises a portion defining a hollow right vertical cylinder defining a chamber adapted to receive a cylindrical beverage container, in sufficiently loose fitting abutment as to allow effective tilting of the beverage container.

Preferably, the base support is in the form of an essentially cylindrical wedge having one side portion of greater height (thickness) than its opposing side portion.

It can be appreciated that the support need not extend fully across the full bottom of the beverage container or its holder, provided a sufficient permanent tilt is incurred by the container, and that any movement of the support in the holder does not cause instability or other movement of the container relative to the support, whereby the location of the aperture relative to the greatest thickness portion of the support does not essentially change.

Suitable dimensions of the support can be readily determined depending on the holder and container dimensions. A typical support has a diameter of about 6 cm and maximum opposing heights of about 2 cm and about 3 mm, respectively.

The support may be a solid or hollow member formed of any suitable material, for example, a shaped stone, rubberized material, plastics material, foam material of a plastic, such as, a polyethylene, polypropylene and polyurethane foam, or the like, or composite of a particulate material such as wood fiber or other cellulosic material or other suitable filler or diluents in admixture with a plastics material. Admixtures may range from 1 to 80% W/W filler.

In alternative embodiments, the base support is in the form of a truncated, cylindrical upper surface-angled hollow cap having a horizontal full surface, upon which the beverage container can rest and having the aforesaid diameter and maximum opposing heights.

In further embodiments, the base support has the form of an upper surface-angled hollow cylinder having circumferential sides of suitable thickness to operably support the beverage container. Such a support, for example, has an outer diameter of about 6 cm, an inner diameter of about 5.2 cm and a wall thickness of about 4 mm. Similarly, the opposing heights are about 2 cm and about 3 mm, respectively.

Preferably, in some embodiments the support may be adapted or formed to receive advertising material.

Dependent on the disposition of the base support within the holder, when one surface, as a bottom surface, is horizontal when resting in abutment on the holder bottom. The higher vertical side of the base support is essentially parallel to the holder inner wall. Inverting the base support to rest the other surface, now as the bottom surface, on the holder bottom causes the higher vertical side of the support to be at about 10° angle to the holder inner wall. Either disposition of the base support in the holder allows of the practice of the invention.

The base support in some embodiments may be adapted to receive means by which the base support is operably retained to a surface of the holder bottom. For example, some cup holders have, in effect, no vertical walls for embracing the container, but wherein the container is retained within an upper ring, typically, retractable from the vehicle facia around an upper part of the container. In one suitable embodiment, the base support may be so shaped at its base to define a recess adapted to be received and operably retained by an upstanding lug on the holder bottom. In alternative embodiments, the holder bottom has a portion defining a recess, cavity or aperture adapted to receive a complementary protrusion of the base support.

In an alternative embodiment, the bottom surface of the support has adhered thereto in whole or in part a double adhesive surface member whereby the other adhesive surface is adhered to the holder bottom.

In alternative embodiments, the holder bottom has a portion defining a recess, or cavity aperture adopted to receive a complementary protrusion of the base support.

In these embodiments, the base support is operably retained affixed to the holder bottom while providing the desired angled disposition to provide the benefits of the invention as hereinabove described.

In a further aspect, the invention provides a base support of use in the system according to the invention, as hereinabove defined.

### BRIEF DESCRIPTION OF THE DRAWINGS

In order that the invention may be better understood, preferred embodiments will now be described by way of example only, wherein

FIGS. 1 and 3 are diagrammatic cross-sectional views of beverage containers holding a beverage and retained in a holder of a vehicle according to a prior art system;

FIGS. 2 and 4 are diagrammatic cross-sectional views of beverage containers holding a beverage resting on a support retained in a holder of a vehicle of a system according to the invention system;

FIG. 5 is a perspective view of a hollow cap base support of use in the practice of the invention;

FIG. 6 is a perspective view of a truncated hollow cylindrical base support of use in the practice of the invention;

FIGS. 7 and 8 are diagrammatic, partly cut away views of a cup holder integrally formed in the plastics interseat molding in a vehicle having a cup support integrally forms in the wall or base of the holder, respectively;

FIGS. 9-12 show diagrammatic vertical sections of base supports having a variety of container holder retaining means according to the invention;

and wherein the same numerals denote like parts.

### DETAILED DESCRIPTION OF PREFERRED EMBODIMENTS

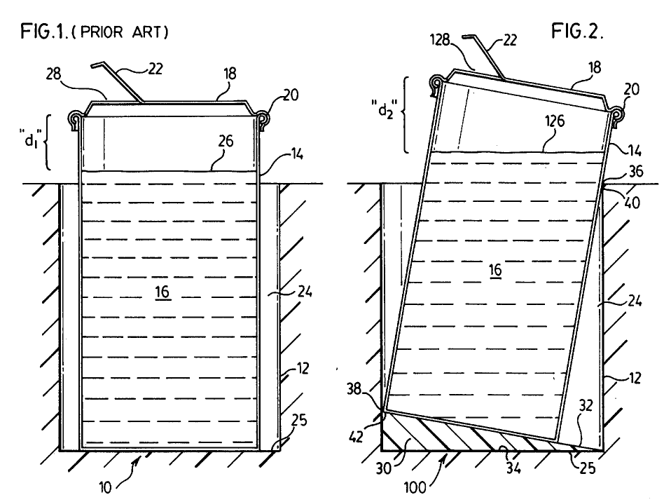

With reference to FIG. 1, this shows generally as 10, a beverage container holder 12 of a vehicle (not shown) retaining a beverage container 14 containing a beverage 16, for example, coffee, tea, fruit drinks, cola and the like. Container 14 has a lid 18 having a rim 20 and a detachable portion 22. Holder 12 defines a chamber 24 having a base 25 upon which container 14 rests.

Beverage 16 has a liquid level 26 equidistant “d”, from lid 18 across the full surface of beverage 16. Displacement and, optionally, detachment of portion 22 of lid 18 creates an aperture 28 through which beverage 16 may be drank.

FIG. 1 shows beverage container or cup 14 in the form of a hollow cylinder, whereas FIG. 3 shows generally as 100, a tapered container 214 in the form of an inverted frustum of right circular cone.

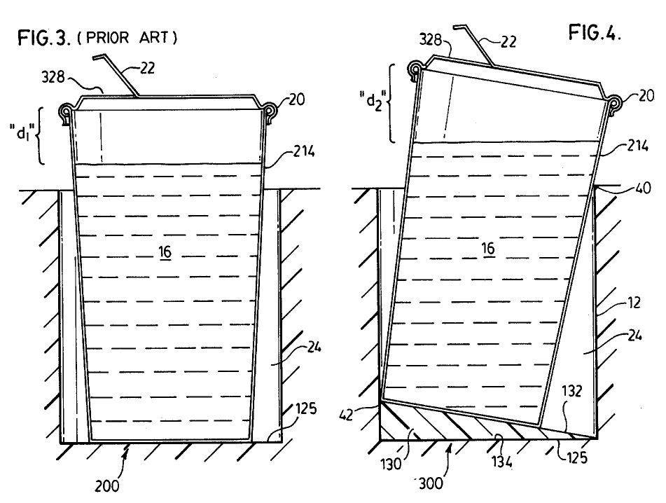

FIGS. 2 and 4, shown generally as 100 and 300, respectively, holder 12 having a base 25, 125, respectively, upon which rests a base support 30, 130, respectively, in the form of a solid, truncated cylinder having its upper surface 32, 132, respectively, non-parallel to its respective base 34, 134, and formed of a plastics material, such as, for example, polyethylene, polypropylene and upon which support 30, 130, rests beverage container 14 holding beverage 16.

The presence of supports 30, 130 is to cause container 14 to be tilted and suitably locating container 14 on supports 30, 130 to locate apertures 128 and 328 directly above the thicker region of supports 30 and 130, respectively, to provide a greater distance “d₂” for the same volume of liquid in the beverage containers, relative to “d”.

Thus, the swishing upwards of beverage 16 in containers 14 and 114 caused by rapid accelerating or deceleration, or the rapid turning of the vehicle greatly reduces the likelihood of spilling through apertures 128, 328.

Further, the presence of support 30 causes a reduced movement of containers 14 and 214 in chamber 24, since upper portion 36 and bottom portion 38 of the container side abut the opposing wall of holder 12 at 40, 42, respectively, by frictional contact, to provide a more rigid fit.

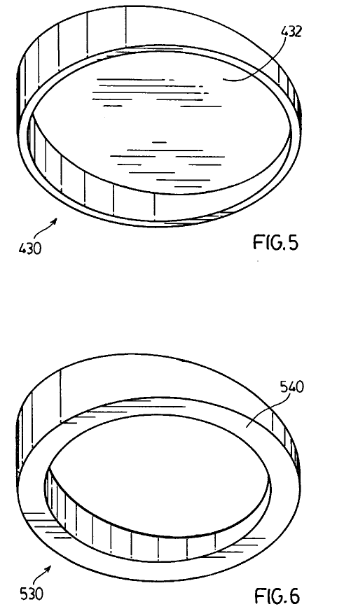

In an alternative embodiment shown in FIG. 5, support 430 is in the form of a truncated hollow, right vertical cylindrical cap having an angled upper surface 432 and walls 434 of different heights, and upon which support 430 beverage cup 14 is suitably tilted.

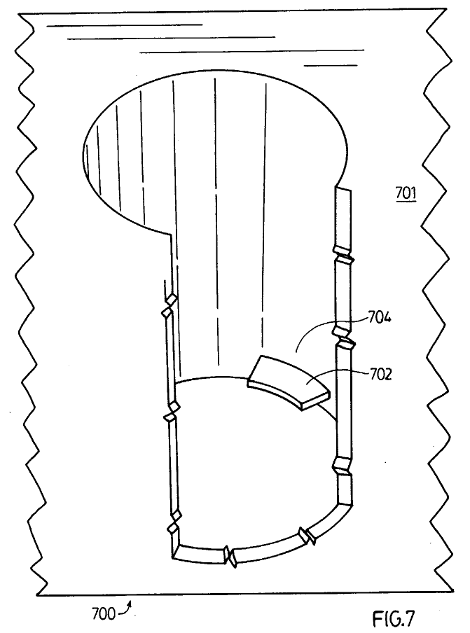

FIG. 6 shows an alternative support 530, of use in the practice of the invention, in the form of a truncated hollow right vertical cylinder having an inclined upper circumferential wall 532 of a suitable thickness to support beverage cup 14 suitably tilted, there upon.

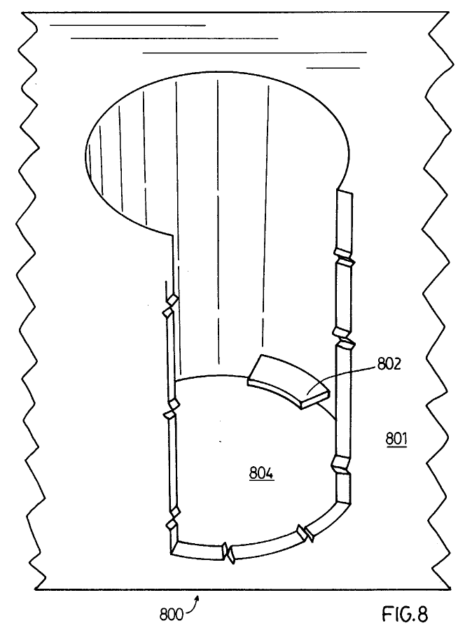

FIG. 7 shows, generally, as 700, a vehicle beverage holder within a plastics molded interseat center piece 701 of a vehicle and having and integrally formed support 702 in the form of a crescent-shaped protrusion extending outwardly from and partially around inner wall 704 and upon which support 702 the beverage cup is suitably tilted.

FIG. 8 shows, generally as 800, a vehicle beverage holder within a plastics molded interseat center piece 801 of a vehicle and having and, having an integrally formed support 802 in the form of a crescent-shaped protrusion extending upwardly from and partially around base 804 and upon which support 802 the beverage cup is suitably tilted.

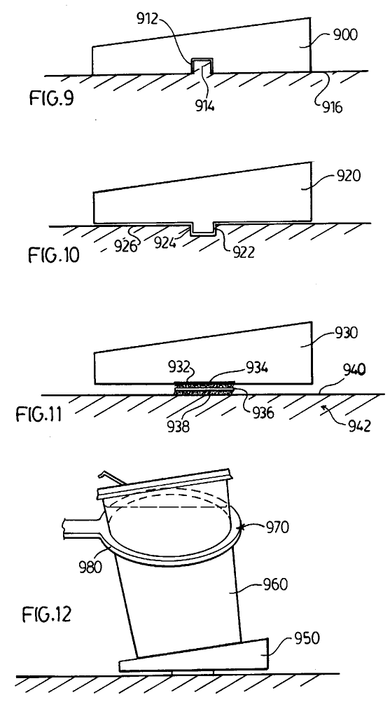

FIG. 9 shows a base support 900 having a base portion defining a cavity 912 which receives upstanding lug 914 of holder 916.

FIG. 10 shows base support 920 having a protrusion 922 which is received in cavity 924 of holder 926.

FIG. 11 shows base support 930 having a lower surface portion 932 adhered to the upper surface 934 of a double adhesive surface member 936. Lower surface 938 of member 936 is adhered to upper surface 940 of holder 942.

FIG. 12 shows base support 950 holding container 960 within and on a “wall-less” holder 970 having a retractable embracing ring 980.

It will be understood, that the diameters, heights, angles, thicknesses, strengths and nature of materials can be readily selected to provide the required support for beverage cups 14, which often are available in a plurality of sizes.

In embodiments having a solid full surface area extending across the top of the support, the support may be provided with one or more suitable top and/or side apertures to facilitate removal of the support, if and when desired, from the vehicle holder, by means of fingers, pick or other grasping article.

Although this disclosure has described and illustrated certain preferred embodiments of the invention, it is to be understood that the invention is not restricted to those particular embodiments. Rather, the invention includes all embodiments, which are functional or mechanical equivalence of the specific embodiments and features that have been described and illustrated.

1. A beverage cup retaining system in a vehicle, comprising, in combination,
(i) a beverage container holder means within the vehicle;
(ii) a beverage container for holding liquid beverage, having a lid with a displaceable portion to provide an aperture in said lid through which said beverage may be drank, and retained within said vehicle holder means; and
(iii) support means within said holder means and upon which the beverage container rests; and wherein said support means is so shaped as to cause said beverage container to be sufficiently tilted when resting on said support means as to cause the level of the beverage adjacent said aperture to be lower than the level of the beverage when said container is horizontal.

2. A system as claimed in claim 1 wherein said holder means defines a portion selected from a lower part or at the base of said holder means, and wherein said support means is integrally formed with said holder means at said lower part or said base of said holder means.

3. A system as claimed in claim 2 wherein said portion is a protrusion extending outwardly around a circumferential portion of said holder means, or extending upwardly from a circumferential portion of said base.

4. A system as claimed in claim 1, comprising, in combination,
(a) a beverage container, for retaining a liquid beverage, having a lid with a displaceable portion, to provide an aperture in said lid through which said beverage may be drank;
(b) holder means having an inner base in a vehicle for holding said beverage container; and
(c) a base support within said holder means and upon said support, said beverage container rests within said holder means; and wherein said support is so shaped as to cause said beverage container to be sufficiently tilted when resting on said support as to cause the level of the beverage adjacent said aperture to be lower than the level of the beverage when said container is horizontal.

5. A system as claimed in claim 4 wherein said holder means comprises a portion defining a hollow right vertical cylinder defining a chamber adapted to receive a cylindrical beverage container, in sufficiently loose fitting abutment as to allow effective tilting of said container.

6. A system as claimed in claim 4 wherein said base support is in the form of an essentially cylindrical wedge having one side portion of greater height (thickness) than its opposing side portion.

7. A system as claimed in claim 5 wherein said base support is in the form of an essentially cylindrical wedge having one side portion of greater height (thickness) than its opposing side portion.

8. A system as claimed in claim 4 wherein said base support is a solid member.

9. A system as claimed in claim 4 wherein said base support comprises the form of a truncated hollow cylindrical upper surface-angled cap.

10. A system as claimed in claim 5 wherein said base support comprises the form of a truncated hollow cylindrical upper surface-angled cap.

11. A system as claimed in claim 6 wherein said base support comprises the form of a truncated hollow cylindrical upper surface-angled cap.

12. A system as claimed in claim 4 wherein said base support comprises the form of a truncated hollow upper surface-angled right vertical cylinder.

13. A system as claimed in claim 1 wherein said holder has an upstanding lug and said base support has a cavity adapted to said lug to effect retention of said base support on said holder.

14. A system as claimed in claim 1 wherein said base support has a protrusion and said holder has a cavity adapted to receive said protrusion to effect retention of said base support on said holder.

15. A system as claimed in claim 1 further comprising adhesion means located between said base support and said holder to effect retention of said base support to said holder.

16. A system as claimed in claim 1 wherein said beverage container holder means comprises a container embracing ring which operably embraces said container to provide stability to said container upon said base support.

17. A base support as defined in claim 1 formed of a material selected from the group consisting of shaped stone, rubberized material, plastics material, foam material of a plastic, such as, a polyethylene, polypropylene and polyurethane foam, or the like, or composite of a particulate material such as wood fiber, or other cellulosic material or other suitable filler, organic or inorganic filler or diluents in admixture with a plastics material.

18. A base support as defined in claim 2 formed of a material selected from the group consisting of shaped stone, rubberized material, plastics material, foam material of a plastic, such as, a polyethylene, polypropylene and polyurethane foam, or the like, or composite of a particulate material such as wood fiber, or other cellulosic material or other suitable filler, organic or inorganic filler or diluents in admixture with a plastics material.

19. A base support as defined in claim 3 formed of a material selected from the group consisting of shaped stone, rubberized material, plastics material, foam material of a plastic, such as, a polyethylene, polypropylene and polyurethane foam, or the like, or composite of a particulate material such as wood fiber, or other cellulosic material or other suitable filler, organic or inorganic filler or diluents in admixture with a plastics material.

20. A base support as defined in claim 4 formed of a material selected from the group consisting of shaped stone, rubberized material, plastics material, foam material of a plastic, such as, a polyethylene, polypropylene and polyurethane foam, or the like, or composite of a particulate material such as wood fiber, or other cellulosic material or other suitable filler, organic or inorganic filler or diluents in admixture with a plastics material.
